(19) United States
(12) Patent Application Publication
(10) Pub. No.: US 2025/0368052 A1
(43) Pub. Date: Dec. 4, 2025

(54) SOLAR CHARGING SYSTEM

(71) Applicant: TOYOTA JIDOSHA KABUSHIKI KAISHA, Toyota-shi (JP)

(72) Inventor: Yukinori MURAKAMI, Toyota-shi (JP)

(73) Assignee: TOYOTA JIDOSHA KABUSHIKI KAISHA, Toyota-shi (JP)

(21) Appl. No.: 19/016,613

(22) Filed: Jan. 10, 2025

(30) Foreign Application Priority Data
May 30, 2024 (JP) 2024-087924

(51) Int. Cl. B60L 8/00; B60L 53/51; H02J 7/35; H02S 50/10

(52) U.S. Cl. CPC B60L 8/003; B60L 53/51; H02J 7/35; H02S 50/10; H02J 2300/26

(57) ABSTRACT

A solar charging system using a plurality of layer panels configured by laminating a plurality of solar panels, an acquisition unit for acquiring an actual power generation amount in the first solar panel and the second solar panel constituting a plurality of layer panels, respectively, a calculation unit for calculating a power generation amount predicted by the second solar panel based on an actual power generation amount of the first solar panel, and calculating a power generation amount predicted by the first solar panel based on an actual power generation amount of the second solar panel, and an abnormality determination unit for determining an abnormality of a sensor for measuring an abnormality or a state of the plurality of layer panels based on a difference between the actual power generation amount and the predicted power generation amount in each of the first solar panel and the second solar panel.

### CROSS-REFERENCE TO RELATED APPLICATION

This application claims priority to Japanese Patent Application No. 2024-087924 filed on May 30, 2024, incorporated herein by reference in its entirety.

### BACKGROUND

### 1. Technical Field

The present disclosure relates to a solar charging system that uses a plurality of solar panels.

### 2. Description of Related Art

Japanese Unexamined Patent Application Publication No. 2020-141545 (JP 2020-141545 A) discloses a solar charging system that uses a plurality of solar panels mounted on a vehicle. The solar charging system acquires the power generation amount for each of the solar panels and the power amount required by a power supply destination, and appropriately controls driving of a plurality of power converters provided in correspondence with the solar panels based on the acquisition results.

### SUMMARY

Conventionally, an abnormality that occurs in a solar power generation system that controls a solar panel is detected by detecting a significant change in a measurement value from a sensor that measures a state (voltage, current, temperature, and the like) of the solar panel. The significant change is a change in which the measurement value from the sensor rises to a high value that exceeds a defined predetermined range or falls to a low value that falls below the predetermined range.

However, such a detection method involves an issue that it is not possible to detect an abnormality in which the measurement value from the sensor does not deviate from the predetermined range, even if an abnormality of the sensor can be detected by detecting a significant change in the measurement value. The abnormality in which the measurement value from the sensor does not deviate from the predetermined range is an abnormality such as deterioration of the solar panel, for example.

The present disclosure has been made in view of the above issue, and has an object to provide a solar charging system capable of accurately detecting an abnormality caused by a solar panel or an abnormality caused by a sensor that measures a state of the solar panel.

In order to address the above issue, an aspect of the present disclosure provides
a solar charging system that uses a plurality of layer panels constituted by stacking a plurality of solar panels, including:
an acquisition unit that acquires actual power generation amounts for a first solar panel and a second solar panel constituting the layer panels;
a calculation unit that calculates a power generation amount predicted for the second solar panel based on the actual power generation amount for the first solar panel, and that calculates a power generation amount predicted for the first solar panel based on the actual power generation amount for the second solar panel; and
an abnormality determination unit that determines an abnormality of the layer panels or an abnormality of a sensor that measures a state of the layer panels based on a difference between the actual power generation amount and the predicted power generation amount for each of the first solar panel and the second solar panel.

According to the solar charging system of the present disclosure, it is possible to accurately detect an abnormality of a plurality of layer panels, constituted from a plurality of solar panels that receives the same solar radiation, or an abnormality of a sensor that measures a state of the layer panels based on the amount of deviation of the actual power generation amount for a solar panel in a certain layer from a power generation amount predicted from the actual power generation amount for a solar panel in another layer.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a schematic configuration of a solar charging system according to the present embodiment;

FIG. 2 is a diagram illustrating an example of a vehicle equipped with a multi-layer panel;

FIG. 3 is a process flow chart of abnormality presence/absence determination control executed by the control device; and

FIG. 4 is a processing flowchart of abnormality cause determination control executed by the control device.

### DETAILED DESCRIPTION OF EMBODIMENTS

In the solar charging system of the present disclosure, in a plurality of layer panels configured by laminating a plurality of solar panels, the power generation amount of the lower layer panel is estimated from the actual power generation amount of the upper layer panel, or the inverse thereof is estimated, and the presence or absence of an abnormality is determined from the deviation between the actual measured value of the power generation amount and the predicted value in each panel. By this determination, the detection accuracy of abnormality occurring in the solar panel or the sensor related to power generation is improved.

Hereinafter, an embodiment of the present disclosure will be described in detail with reference to the drawings.

### Embodiment

### Configuration

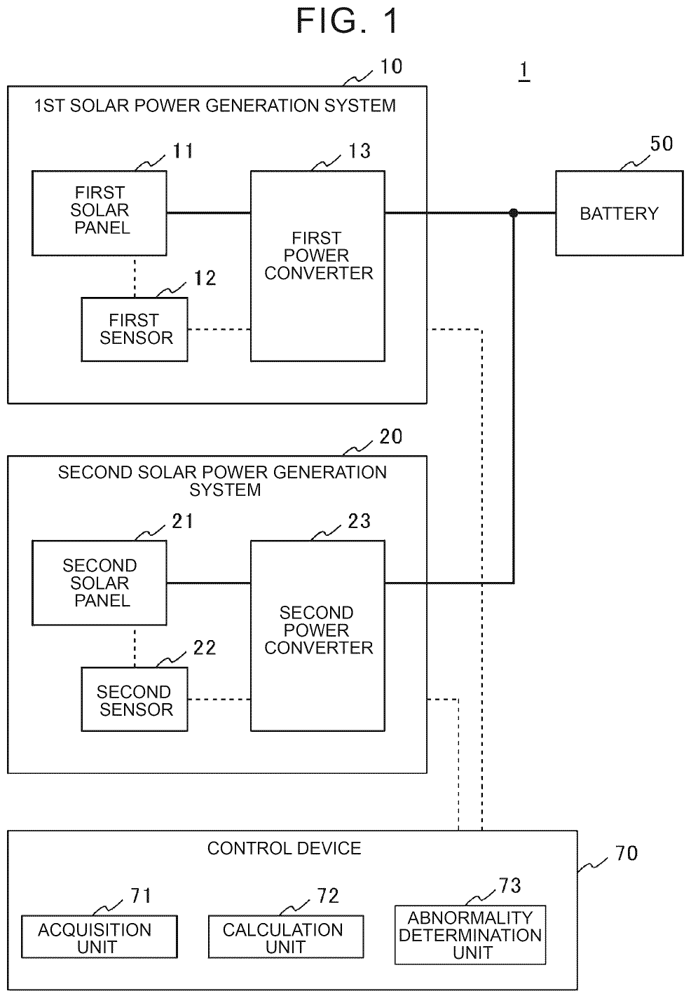

FIG. 1 is a block diagram illustrating a schematic configuration of a solar charging system 1 according to an embodiment of the present disclosure. The solar charging system 1 illustrated in FIG. 1 includes a first solar power generation system 10, a second solar power generation system 20, a battery 50, and a control device 70. The first solar power generation system 10 and the second solar power generation system 20 are connected in parallel with the battery 50. In FIG. 1, a connection line through which electric power is transmitted is indicated by a solid line, and a connection line through which control signals, measurement values, and the like other than electric power are transmitted and received is indicated by a dotted line.

The solar charging system 1 can be mounted on vehicles such as, for example, hybrid electric vehicle (HEV), plug-in hybrid electric vehicle (PHEV), and battery electric vehicle (BEV).

The first solar power generation system 10 includes a first solar panel 11, a first sensor 12, and a first power converter 13 in a configuration, and controls power generation by the first solar panel 11, supply of generated power to the battery 50, and the like.

The first solar panel 11 is configured to generate electric power according to the irradiation amount of sunlight, and is typically an aggregate of solar cells. FIG. 1 illustrates an example in which one first solar panel 11 belongs to the first solar power generation system 10, but the number of solar panels is not limited thereto.

The first sensor 12 is a configuration for acquiring a power generation state of the first solar panel 11. The first sensor 12 measures a physical quantity such as a voltage, a current, and a temperature of the first solar panel 11 as a power generation state. As the first sensor 12, a detection element such as a voltage sensor, a current sensor, or a temperature sensor is used.

The first power converter 13 is a configuration for controlling the generated power of the first solar panel 11. The first power converter 13 typically includes a MPPT control unit that controls electric power generated by the first solar panel 11 by a maximum-power-point tracking method, and a DCDC converter (not shown) that converts the controlled generated electric power into electric power of a predetermined voltage and outputs the electric power to the battery 50.

The second solar power generation system 20 includes a second solar panel 21, a second sensor 22, and a second power converter 23 in a configuration, and controls power generation by the second solar panel 21, supply of generated power to the battery 50, and the like.

The second solar panel 21 is configured to generate electric power corresponding to the irradiation amount of sunlight, and is typically an aggregate of solar cells. FIG. 1 illustrates an example in which one second solar panel 21 belongs to the second solar power generation system 20, but the number of solar panels is not limited thereto.

The second sensor 22 is a configuration for acquiring a power generation state of the second solar panel 21. The second sensor 22 measures a physical quantity such as a voltage, a current, and a temperature of the second solar panel 21 as a power generation state. As the second sensor 22, a detection element such as a voltage sensor, a current sensor, or a temperature sensor is used.

The second power converter 23 is a configuration for controlling the generated power of the second solar panel 21. The second power converter 23 typically includes a MPPT control unit that controls the electric power generated by the second solar panel 21 by a maximum-power-point tracking method, and a DCDC converter (not shown) that converts the controlled generated electric power into electric power of a predetermined voltage and outputs the electric power to the battery 50.

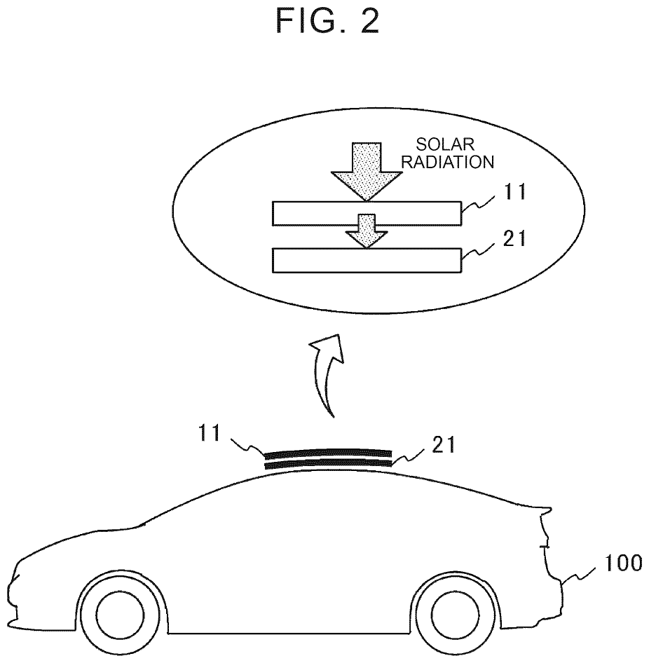

The first solar panel 11 and the second solar panel 21 described above are formed by a structure of a plurality of layer panels stacked in the up-down direction, in which conditions under which solar radiation is received from the sun (such as an area of sunshine and an angle of sunshine) are the same. FIG. 2 shows an example of an image of a multi-layer panel in which the first solar panel 11 and the second solar panel 21 are installed in the vehicle 100.

In the example of FIG. 2, the first solar panel 11 becomes a “top layer panel” that directly receives solar radiation from the sun, and the second solar panel 21 becomes a “bottom layer panel” that indirectly receives solar radiation from the sun through the top layer panel. The first solar panel 11, which is the uppermost layer panel, has the largest power generation amount, and the second solar panel 21, which is the lower layer panel, has a smaller power generation amount than the first solar panel 11. There is a correlation between the power generation amount of the first solar panel 11 and the power generation amount of the second solar panel 21 based on the light transmittance (or light attenuation rate) of the first solar panel 11. Therefore, when the conditions under which solar radiation is received are the same, it is possible to predict the power generation amount of the second solar panel 21 from the actual power generation amount of the first solar panel 11. In addition, it is possible to predict the power generation amount of the first solar panel 11 from the actual power generation amount of the second solar panel 21.

For example, when the first solar panel 11 and the second solar panel 21 have the same power generation performance and the light transmittance of the first solar panel 11 is 50%, if the actual power generation amount (measured value) of the first solar panel 11 is “70 W”, the power generation amount (predicted value) of the second solar panel 21 can be predicted to be “35 W(=70 W×0.5)”.

The battery 50 is a secondary battery configured to be chargeable and dischargeable, such as a lithium ion battery or a lead storage battery. The battery 50 is connected to the first solar power generation system 10 and the second solar power generation system 20, respectively. The battery 50 is configured to be able to charge electric power generated by the first solar panel 11 via the first power converter 13. The battery 50 is configured to be able to charge electric power generated by the second solar panel 21 via the second power converter 23.

Note that the solar power generation system connected in parallel to the battery 50 is not limited to two of the first solar power generation system 10 and the second solar power generation system 20 shown in FIG. 1, and three or more solar power generation systems may be connected to the battery 50. In this case, in proportion to the number of solar power generation systems connected to the battery 50, the number of solar panels (the number of stacked solar panels) stacked as a plurality of layer panels increases.

The control device 70 is configured to determine abnormalities occurring in the first solar power generation system 10 and the second solar power generation system 20. The control device 70 includes an acquisition unit 71, a calculation unit 72, and an abnormality determination unit 73.

The acquisition unit 71 acquires, from the first solar power generation system 10, a power generation amount (hereinafter, referred to as “actual power generation amount”) that is the electric power actually generated by the first solar panel 11. Further, the acquisition unit 71 acquires the actual power generation amount of the second solar panel 21 from the second solar power generation system 20.

The calculation unit 72 calculates the electric power (hereinafter, referred to as “predicted electric power generation amount”) that is predicted to generate electric power in the second solar panel 21 based on the actual electric power generation amount of the first solar panel 11. Further, the calculation unit 72 calculates the predicted power generation amount of the first solar panel 11 based on the actual power generation amount of the second solar panel 21.

The abnormality determination unit 73 determines the presence or absence of abnormality in the first solar power generation system 10 and the second solar power generation system 20 based on the actual power generation amounts of the first solar panel 11 and the second solar panel 21 obtained by the acquisition unit 71 and the calculation unit 72 and the predicted power generation amounts of the first solar panel 11 and the second solar panel 21. The abnormality determination method by the abnormality determination unit 73 will be described later.

Some or all of the control device 70 described above may be configured as an electronic control unit (ECU) that typically includes a processor, memories, input/output interfaces, and the like. The electronic control unit realizes some or all of the functions of the acquisition unit 71, the calculation unit 72, and the abnormality determination unit 73 by the processor reading and executing a program stored in the memory.

### Control

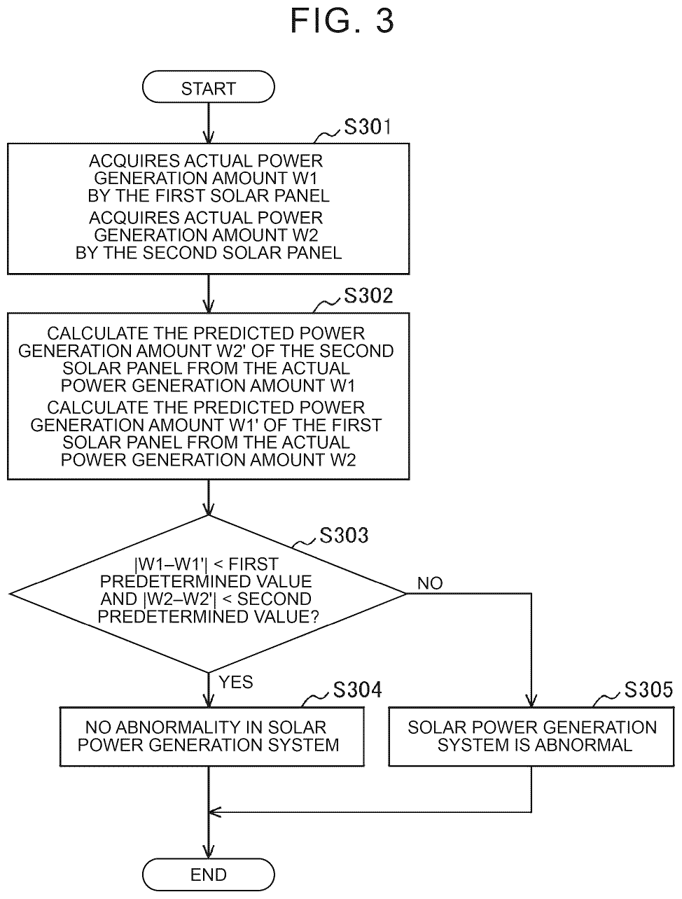

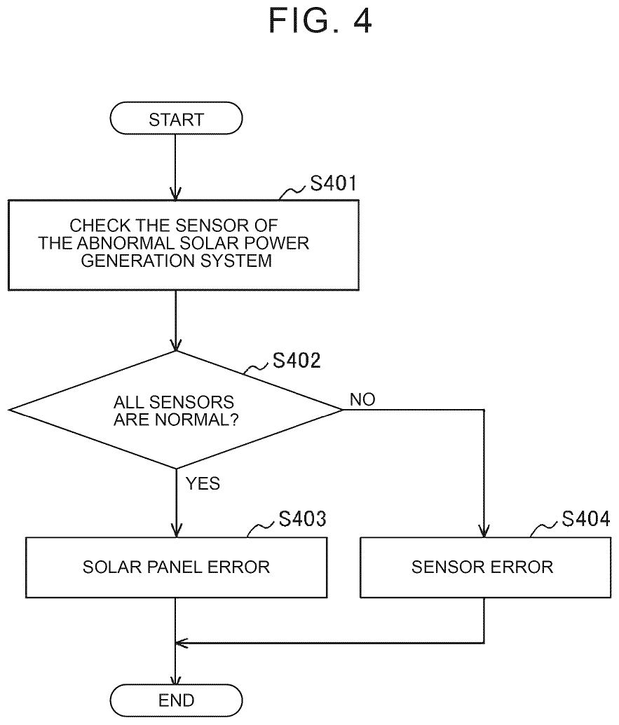

Next, the control performed by the solar charging system 1 according to the present embodiment will be described with further reference to FIGS. 3 and 4.

### Abnormality Determination Control

FIG. 3 is a flowchart illustrating a processing procedure of abnormality presence/absence determination control executed by the control device 70 of the solar charging system 1. This abnormality presence/absence determination control is performed, for example, at an arbitrary timing during a period in which the solar charging system 1 is operating.

### S301

The acquisition unit 71 of the control device 70 acquires the actual power generation amount W1 of the first solar panel 11. Further, the acquisition unit 71 acquires the actual power generation amount W2 of the second solar panel 21. The actual power generation amount W1 and the actual power generation amount W2 can be derived from the measured values (voltage, current, temperature, and the like) acquired by the first sensor 12 and the second sensor 22, respectively. The timing of acquiring the measurement values from the first sensor 12 and the second sensor 22 is preferably the same so that the influence of solar radiation received from the sun between the first solar panel 11 and the second solar panel 21 does not change.

When the acquisition unit 71 acquires the actual power generation amount W1 of the first solar panel 11 and the actual power generation amount W2 of the second solar panel 21, the process proceeds to S302.

### S302

The calculation unit 72 of the control device 70 calculates the power generation amount W2′ predicted in the second solar panel 21 from the actual power generation amount W1 of the first solar panel 11. Further, the calculation unit 72 calculates a power generation amount W1′ predicted in the first solar panel 11 from the actual power generation amount W2 of the second solar panel 21.

The predicted power generation amount W1′ and the predicted power generation amount W2′ can be estimated from the actual power generation amount W1 and the actual power generation amount W2 based on the light transmittance (or light attenuation rate) of the first solar panel 11. For example, when the optical transmittance a (0<a<1) is used, the predicted power generation amount W1′ and the predicted power generation amount W2′ can be obtained by Equations 1 and 2 below.

$$Predicted power generation amount W {1}^{′} = Acutal power generation amount W 2 \times ( 1 / a ) \qquad ( Equation 1 )$$

$$Predicted power generation amount W {2}^{′} = Acutal power generation amount W 1 \times a \qquad ( Equation 2 )$$

When the calculation unit 72 calculates the predicted power generation amount W1′ of the first solar panel 11 and the predicted power generation amount W2′ of the second solar panel 21, the process proceeds to S303.

S303

The abnormality determination unit 73 of the control device 70 determines the deviation between the actual power generation amount W1 in the first solar panel 11 and the predicted power generation amount W1′, and the deviation between the actual power generation amount W2 in the second solar panel 21 and the predicted power generation amount W2′, respectively. More specifically, the abnormality determination unit 73 determines whether or not the absolute value (|W1−W1′|) of the difference between the actual power generation amount W1 of the first solar panel 11 and the predicted power generation amount W1′ is less than the first predetermined value. Further, the abnormality determination unit 73 determines whether or not the absolute value (|W2−W2′|) of the difference between the actual power generation amount W2 of the second solar panel 21 and the predicted power generation amount W2′ is less than the second predetermined value.

When the abnormality determination unit 73 determines that the absolute value of the difference between the actual power generation amount W1 and the predicted power generation amount W1′ is less than the first predetermined value and that the absolute value of the difference between the actual power generation amount W2 and the predicted power generation amount W2′ is less than the second predetermined value (S303, Yes), the process proceeds to S304. On the other hand, when the abnormality determination unit 73 determines that the absolute value of the difference between the actual power generation amount W1 and the predicted power generation amount W1′ is equal to or greater than the first predetermined value, and/or when it determines that the absolute value of the difference between the actual power generation amount W2 and the predicted power generation amount W2′ is equal to or greater than the second predetermined value (S303, no), the process proceeds to S305. S304

The measured value and the predicted value in the first solar panel 11 and the second solar panel 21 do not significantly deviate from each other. Therefore, the abnormality determination unit 73 of the control device 70 determines that there is no abnormality in both the first solar power generation system 10 and the second solar power generation system 20.

When the abnormality determination unit 73 determines that there is no abnormality in the solar power generation system, this abnormality presence/absence determination control ends.

### S305

The measured value and the predicted value in one or both of the shift values of the first solar panel 11 and the second solar panel 21 greatly deviate from each other. Therefore, the abnormality determination unit 73 of the control device 70 determines that there is an abnormality in the power generation system of at least one of the first solar power generation system 10 and the second solar power generation system 20.

When the abnormality determination unit 73 determines that there is an abnormality in the solar power generation system, this abnormality presence/absence determination control ends.

### Abnormality Cause Determination Control

FIG. 4 is a flowchart illustrating a processing procedure of abnormality cause determination control executed by the control device 70 of the solar charging system 1. The abnormality cause determination control is performed when the abnormality of the solar power generation system is determined in the above-described abnormality presence/absence determination control.

### S401

The abnormality determination unit 73 of the control device 70 checks the first sensor 12 and the second sensor 22 of the solar power generation system determined to be abnormal, that is, the first solar power generation system 10 and the second solar power generation system 20, respectively. This sensor can be checked by a well-known method such as, for example, determining a fault or abnormality based on a voltage, a current, or a temperature obtained by the sensor.

When all the sensors of the solar power generation system determined to be abnormal are checked by the abnormality determination unit 73, the process proceeds to S402.

### S402

The abnormality determination unit 73 of the control device 70 determines whether or not all the sensors checked in the above S401, that is, the first sensor 12 and the second sensor 22 are normal.

When the abnormality determination unit 73 determines that all the checked first sensors 12 and second sensors 22 are normal (S402, Yes), the process proceeds to S403. On the other hand, when the abnormality determination unit 73 determines that at least one of the checked first sensor 12 and second sensor 22 is not normal (S402, No), the process proceeds to S404.

### S403

The abnormality determination unit 73 of the control device 70 determines that there is an abnormality in one or both of the first solar panel 11 and the second solar panel 21 because the sides of the first sensor 12 and the second sensor 22 are normal.

When the abnormality determination unit 73 determines that there is an abnormality in the solar panel, the abnormality cause determination control ends.

### S404

Since the side of the first sensor 12 and the side of the second sensor 22 are not normal, the abnormality determination unit 73 of the control device 70 determines that there is an abnormality in the first sensor 12 and/or the second sensor 22 that is not normal.

When the abnormality determination unit 73 determines that there is an abnormality in the sensor, the abnormality cause determination control ends. Effects

As described above, the solar charging system 1 using the multi-layer panels (11, 21) according to the embodiment of the present disclosure calculates the predicted power generation amount (W1′, W2′) using the actual power generation amount (W1, W2) in the multi-layer panels (11, 21) having the same conditions for receiving solar radiation to the plurality of solar panels. Then, the solar charging system 1 determines the presence or absence of an anomaly in the solar power generation system (10, 20) based on the magnitude of the deviation between the actual measured value of the power generation amount (W1,W2) and the predicted value of the power generation amount (W1′, W2′).

By this determination method, it is possible to detect an abnormality such as deterioration of the solar panels (11, 21) in which the measured values of the sensors (12, 22) generated in the solar charging system 1 do not fall outside the specified range.

In addition, the solar charging system 1 according to the present embodiment performs a sensor check on the solar power generation system (10, 20) that has determined that there is an abnormality. Therefore, it is possible to accurately determine whether the cause of the abnormality occurs in the solar panel (11, 21) or the sensor (12, 22) that measures the state of the solar panel (11, 21).

The solar charging system of the present disclosure can be used in a vehicle equipped with a plurality of solar panels.

What is claimed is:

1. A solar charging system that uses a plurality of layer panels constituted by stacking a plurality of solar panels, comprising:
an acquisition unit that acquires actual power generation amounts for a first solar panel and a second solar panel constituting the layer panels;
a calculation unit that calculates a power generation amount predicted for the second solar panel based on the actual power generation amount for the first solar panel, and that calculates a power generation amount predicted for the first solar panel based on the actual power generation amount for the second solar panel; and
an abnormality determination unit that determines an abnormality of the layer panels or an abnormality of a sensor that measures a state of the layer panels based on a difference between the actual power generation amount and the predicted power generation amount for each of the first solar panel and the second solar panel.

2. The solar charging system according to claim 1, wherein the abnormality determination unit determines that at least one of the first solar panel and the second solar panel is abnormal when a measurement value from the sensor is within a predetermined range, and determines that the sensor is abnormal when the measurement value from the sensor is outside the predetermined range.

3. The solar charging system according to claim 1, wherein:
the first solar panel is a panel installed in an uppermost surface layer of the layer panels; and
the second solar panel is a panel installed in a lower surface layer other than the uppermost surface layer of the layer panels.
